(19) United States
(12) Patent Application Publication
(10) Pub. No.: US 2024/0337340 A1
(43) Pub. Date: Oct. 10, 2024

(54) MULTIFUNCTIONAL PIPE

(71) Applicant: YONGKANG HAILI INDUSTRIAL Co., Ltd., Yongkang City, Zhejiang (CN)

(72) Inventor: Yujun SHAO, Yongkang City, Zhejiang (CN)

(21) Appl. No.: 17/777,937

(22) PCT Filed: Nov. 29, 2021
(86) PCT No.: PCT/CN2021/133908

§ 371 Date: Feb. 3, 2024

(30) Foreign Application Priority Data
Jul. 27, 2021 (CN) 202110848368.3

(51) Int. Cl. F16L 53/38; F16L 9/147; F16L 25/01; F16L 57/00

(52) U.S. Cl. CPC F16L 53/38; F16L 9/147; F16L 25/01; F16L 57/00

(57) ABSTRACT

The multifunctional pipe includes a water pipe connector is arranged at each of the ends of both sides of a water pipe; and an electric pipe sleeve arranged on one side of the water pipe. The electric pipe sleeve is formed by extruding a cable, including extruding an outer surface of the cable. A water pipe jacket is formed by extruding an outer surface of the water pipe are of an integrally formed integral structure. Two ends of both sides of the cable extend out of the ends of the corresponding sides of the electric pipe sleeve. The outermost layer of the water pipe of a device and the electric pipe sleeve are of an integrated structure, which can improve the production efficiency of the water pipe and an electric pipe. The self-temperature-limiting heating tape can also heat a water faucet.

### CROSS-REFERENCE TO RELATED APPLICATIONS

This application claims priority to Chinese patent application No. 202110848368.3, filed to the China National Intellectual Property Administration on 27 Jul. 2021 and entitled “MULTIFUNCTIONAL PIPE”, the disclosure of which is hereby incorporated by reference in its entirety. See also Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a multifunctional pipe which has good applicability, low production cost, high production efficiency, good use effect, good use safety, and long service life, and can even supply power and supply water simultaneously and ensure that a water pipe does not ice, which belongs to the technical field of hydroelectric pipes.

### 2. Description of Related Art Including Information Disclosed Under 37 CFR 1.97 and 37 CFR 1.98.

Water pipe icing is a common phenomenon, especially in cold areas. A water pipe icing phenomenon will not only have a great impact on the production and life of people, but also may prop to crack a water pipe due to volume expansion of ice after water ices, which will cause greater damage to a water supply system.

The existing anti-icing device for a water supply system, such as CN 207921575 U with the name of “anti-freezing Polyvinyl Chloride (PVC) water pipe”, includes a PVC pipe body and a heater. A heating layer is arranged on the PVC pipe body. A heat insulating layer is arranged outside the heating layer. A protective layer is arranged outside the heat insulating layer. The heating layer is fixedly connected to the heater through a heat conducting pipe. An insulating sleeve is arranged inside the heater. One end of the PVC pipe body is spirally connected to a connecting pipe. A water valve is arranged on one side of the connecting pipe. The other end of the connecting pipe is spirally connected to an anti-freezing pipe. One side of the anti-freezing pipe is spirally connected to a water faucet. The heat conducting pipe is made of a graphene material. The heat conducting pipe is spirally arranged on the PVC pipe body in a winding manner. The insulating sleeve wraps a heated end of the heat conducting pipe, and the insulating sleeve is made of a ceramic material. The length of the insulating sleeve is greater than that of a contact surface between the heater and the insulating sleeve, and the heater is of an electromagnetic heating structure. Sealing rings are arranged inside two ends of the connecting pipe, and the sealing rings are circular silicone colloid. The anti-freezing pipe is of a conical structure, and rubber and plastic sponge is arranged on an outer wall of the anti-freezing pipe. A water faucet is arranged at 2-6 cm of a flared end of a water inlet end of the anti-freezing pipe, and the pipe diameter of the water inlet end of the anti-freezing pipe is greater than that of the connecting pipe. Such anti-freezing PVC water pipe has the advantages that: first, a heating wire in the anti-freezing PVC water pipe is arranged on the PVC water pipe in a winding manner, and meanwhile, the heat insulating layer, the protective layer, and the insulating layer need to be additionally arranged on the outer side of the heating wire, which not only has a complex structure, but also increases the production cost of the anti-freezing water pipe; second, after the anti-freezing PVC pipe is connected to the water faucet, a water outlet of the closed water faucet cannot be effectively heated (the heating wire generally heats the PVC water pipe at about 30° C.), which easily causes a problem of icing at the water outlet of the water faucet; and third, the anti-freezing PVC water pipe is not provided with a leakage protection safety device, so the use safety is poor.

### BRIEF SUMMARY OF THE INVENTION

Design purpose: in order to avoid the disadvantages in the background art, a multifunctional pipe which has good applicability, low production cost, high production efficiency, good use effect, good use safety and long service life, and can even supply power and supply water simultaneously and ensure that a water pipe does not ice is designed.

Design solution: it is designed to achieve the abovementioned design purpose.

1. The design that an electric pipe sleeve is arranged on one side of a water pipe, and the electric pipe sleeve is formed by extruding a cable, the electric pipe sleeve formed by extruding an outer surface of the cable and a water pipe jacket formed by extruding an outer surface of the water pipe are of an integrally formed integral structure, and two ends of both sides of the cable extend out of the ends of the corresponding sides of the electric pipe sleeve is a first technical feature of the present invention. The purpose of this design is that: first, the electric pipe sleeve is arranged on one side of the water pipe, and the electric pipe sleeve is formed by extruding the cable, which not only realizes the separation of water from electricity, but also improves the use reliability; second, the electric pipe sleeve formed by extruding the outer surface of the cable and the water pipe jacket formed by extruding the outer surface of the water pipe are of the integrally formed integral structure, that is, the outermost layer of the water pipe and the electric pipe sleeve are of an integrated structure, thus, the firmness of the electric pipe sleeve can be enhanced, the production efficiency of the water pipe and the electric pipe can be improved, and meanwhile, the production cost is relatively low; third, the two ends of both sides of the cable extend out of the ends of the corresponding sides of the electric pipe sleeve, which facilitates subsequence wiring of the cable; and fourth, when the cable is a self-temperature-limiting heating tape, it can ensure that the water pipe does not ice; or when the cable is a conductive wire, power and water can be supplied simultaneously; or the cable is a self-temperature-limiting heating tape and the conductive wire, that is, the electric pipe sleeve is provided with the self-temperature-limiting heating tape and the conductive wire at the same time, so that power and water can be supplied at the same time and it can ensure that the water pipe does not ice, thereby greatly improving the application range of the pipe.

2. The design that the water pipe consists an intermediate pipe section and two flared pipe sections, the flared pipe section is horn-shaped, a wide mouth diameter of the flared pipe section is matched with the diameter of the water pipe connector, and a narrow mouth diameter of the flared pipe section is matched with the diameter of the intermediate pipe section is a second technical feature of the present invention. The purpose of this design is that: the water pipe consists of the intermediate pipe section and the two flared pipe sections, the flared pipe section is horn-shaped, the wide mouth diameter of the flared pipe section is matched with the diameter of the water pipe connector, and the narrow mouth diameter of the flared pipe section is matched with the diameter of the intermediate pipe section. The arrangement of the flared pipe section makes that the water pipe connector can be internally connected to the water faucet, or can be internally connected to a pipeline in a water supply system, thus, the connection is more convenience, and a connector does not leak water easily; and in addition, the electric pipe sleeve is located between the two flared pipe sections, so that the flared pipe sections have a certain protective effect on the electric pipe sleeve sunken between the two flared pipe sections.

3. The design that a sheath is arranged on each of the ends of both sides of the water pipe in a sleeving manner, the sheath covers the corresponding flared pipe section and part of the intermediate pipe section, the length of the parts, extending out of two ports of the electric pipe sleeve, of the self-temperature-limiting heating tape is greater than that of the corresponding flared pipe section is a third technical feature of the present invention. The purpose of this design is that: first, the sheath is arranged on each of the ends of both sides of the water pipe in a sleeving manner, and the sheath covers the corresponding flared pipe section and part of the intermediate pipe section, so that the sheath achieves a protective effect on the flared pipe section; second, the length of the parts, extending out of the two ports of the electric pipe sleeve, of the self-temperature-limiting heating tape is greater than that of the corresponding flared pipe section, meanwhile, the water pipe connector on one side needs to connect the water faucet, and the corresponding self-temperature-limiting heating tape extends (the length of the parts, extending out of the two ports of the electric pipe sleeve, of the self-temperature-limiting heating tape is greater than that of the corresponding flared pipe section) and is fixed to the water faucet (the sheath is pulled outwards, so that the sheath covers a pipe body part of the water faucet, at this moment, the self-temperature-limiting heating tape is fit to the pipe body part, and then, the sheath still achieves a protective effect on the flared pipe section) after the water faucet is connected, and the self-temperature-limiting heating tape can also heat the water faucet (some water will remain at the water outlet after the water faucet is closed, and in an extremely cold environment below minus 20° C., the remaining water will quickly become ice, which easily affects the use of the water faucet, for example, the water faucet cannot be opened).

4. The design that a plurality of threading holes for the self-temperature-limiting heating tape to penetrate out are formed in the sheath, and when there are a plurality of threading holes, the plurality of threading holes are distributed in a “1”-shape along a symmetrical center line of the sheath is a fourth technical feature of the present invention. The purpose of this design is that: the plurality of threading holes for the self-temperature-limiting heating tape to penetrate out are formed in the sheath; and when there are a plurality of threading holes, the plurality of threading holes distributed in the “1”-shape along a symmetrical center line of the sheath, so that a user can select a suitable threading hole for the self-temperature limiting heating tape to penetrate out according to the requirement, thereby improving the applicability of the sheath.

5. The design that a plurality of grooves are formed in an inner wall surface of the sheath in a direction of the symmetrical center line of the sheath, and the grooves penetrate through the end surfaces of both sides of the sheath is a fifth technical feature of the present invention. The purpose of this design is that: the diameter of the intermediate pipe section is greater than the diameter of the inner wall surface of the sheath, and a plurality of grooves are formed in the inner wall surface of the sheath along the symmetrical center line of the sheath, so that the sheath can be propped larger (in the case of the same material, the inner wall surface, provided with the grooves, of the sheath can be propped larger compared with the inner wall surface, not provided with the grooves, of the sheath), so that the sheath fixes the self-temperature limiting heating tape extending onto the water faucet.

6. The design that the water pipe consists of an inner PVC layer, an intermediate yarn layer, and an outer PVC layer, and the intermediate yarn layer is located between the inner PVC layer and the outer PVC layer is a sixth technical feature of the present invention. The purpose of this design is that: the water pipe consists of the inner PVC layer, the intermediate yarn layer, and the outer PVC layer, and the intermediate yarn layer is located between the inner PVC layer and the outer PVC layer, so that the arrangement of the intermediate yarn layer can enhance the strength of the water pipe.

7. The design that the intermediate yarn layer is a metal ring woven by metal wires, a directional heat conductor formed by a metal wire section is arranged on one side of the metal ring, the directional heat conductor is coated in the outer PVC layer, the directional heat conductor directly faces an inner cavity of the electric pipe sleeve, and an outer end of the metal wire section in the directional heat conductor does not extend out of an inner cavity wall of the electric pipe sleeve is a seventh technical feature of the present invention. The purpose of this design is that: first, the directional heat conductor can quickly conduct the heat generated by the self-temperature-limiting heating tape to the metal ring (relatively little heat generated by the self-temperature-limiting heating tape escapes outwards through the electric pipe sleeve), so that the heat on the metal ring can heat the water in the water pipe uniformly through the inner PVC layer, which not only improves the use efficiency of heat energy (reduces the use of electric energy), but also shorten the heating time of water (thus, the water temperature adjustment sensitivity is better, and the water in the water pipe can be ensured not to ice in an environment within minus 50° C.); second, the metal ring is spirally arranged on the inner PVC layer in a sleeving manner, the directional heat conductor formed by the metal wire section can enhance the strength of the pipe body of the wall section, and a loose (a plurality of metal wire sections) directional heat conductor cannot affect the deformation meeting a use requirement (the water pipe consisting of the inner PVC layer, the intermediate yarn layer, and the outer PVC layer is a hose that may deform moderately); and third, the outer end of the metal wire section in the directional heat conductor does not extend out of the inner cavity wall of the electric pipe sleeve, so as to avoid the damage of the metal wire section to the self-temperature-limiting heating tape, thereby guaranteeing the use safety of the device.

8. The design that a rubber coating is arranged at an end of one side of the self-temperature-limiting heating tape, and the end of the other side is connected to a power supply through a power line and a leakage protector is an eighth technical feature of the present invention. The purpose of this design is that: the rubber coating is arranged at the end of one side of the self-temperature-limiting heating tape, and the end of the other side is connected to the power supply through the power line and the leakage protector, so that the arrangement of the leakage protector can improve the use safety of the device.

The multifunctional pipe further includes a fixing piece. The fixing piece is arranged to fix and fit the self-temperature-limiting heating tape to the water pipe connector, so that the fitting degree between the self-temperature-limiting heating tape and the water pipe connector can be improved. When the water pipe connector is connected to the water faucet, the connection can be prevented from icing. Each of both ends of the water pipe is provided with the water pipe connector, so the fixing piece is mounted on the water pipe connector at each of both ends of the water pipe.

In order to further facilitate the fitting of the self-temperature-limiting heating tape to the water pipe connector, the fixing piece is a Velcro tape arranged on the water pipe connector. A first end of the Velcro tape is fixed to the water pipe connector, and a second end is arranegd on the water pipe connector in a winding manner. During use, the second end of the Velcro tape is pulled, so that the Velcro tape is separated from the water pipe connector, then one end, extending out of the sheath, of the self-temperature-limiting heating tape is fit to the water pipe connector, and finally, the fitting of the self-temperature-limiting heating tape and the water pipe connector can be realized by winding the Velcro tape on the water pipe connector and the self-temperature-limiting heating tape.

The technical solution is that: a multifunctional pipe includes a water pipe and a cable. A water pipe connector is arranged at each of the ends of both sides of the water pipe. An electric pipe sleeve is arranged on one side of the water pipe, and the electric pipe sleeve is formed by extruding the cable. The electric pipe sleeve formed by extruding an outer surface of the cable and a water pipe jacket formed by extruding an outer surface of the water pipe are of an integrally formed integral structure. Two ends of both sides of the cable extend out of the ends of the corresponding sides of the electric pipe sleeve.

According to the present invention, compared with the background art, first, the cable in the multifunctional pipe is the self-temperature-limiting heating tape, or the cable is a conductive wire, which greatly improves the application range of the pipe. Second, the outermost layer of the multifunctional pipe and the electric pipe sleeve are of the integrated structure, so that the firmness of the electric pipe sleeve can be enhanced, the production efficiency of the water pipe and the electric pipe sleeve can be improved, and meanwhile, the production cost is relatively low. Third, after one side of the water pipe connector is connected to the water faucet, an outer extending part of the self-temperature-limiting heating tape can be stably fixed to the water faucet through the sheath (the sheath is pulled outwards, so that the sheath covers the pipe body part of the water faucet, at this moment, the self-temperature-limiting heating tape is adhered to the pipe body part, and then, the sheath still achieves a protective effect on the flared pipe section), and at this moment, the self-temperature-limiting heating tape can also heat the water faucet. Fourth, due to the arrangement of the metal rings and the directional heat conductor, more heat can be uniformly guided to the inner side of the pipe body on the premise of not affecting the thickness of the pipe body and a normal deformation requirement, which not only improves the effective utilization rate of heat energy (reduces the energy consumption), but also can heat the water in the water pipe quickly and uniformly, thereby avoiding a problem of extremely cold and extremely hot of water.

### BRIEF DESCRIPTION OF THE SEVERAL VIEWS OF THE DRAWINGS

FIG. 1 is a structural schematic diagram of a front view of a multifunctional pipe (a cable is a self-temperature-limiting heating tape).

FIG. 2 is a structural schematic diagram of a side view of the multifunctional pipe (the cable is the self-temperature-limiting heating tape).

FIG. 3 is a structural schematic diagram of a sectional view of the multifunctional pipe (the cable is the self-temperature-limiting heating pipe).

FIG. 4 is a structural schematic view of a diagram of a sheath.

FIG. 5 is a structural schematic diagram of a sectional view of the multifunctional pipe (added with a directional heat conductor).

FIG. 6 is a structural schematic diagram of a front view of the multifunctional pipe (using a fixing piece).

FIG. 7 is a structural schematic diagram of a side view of the multifunctional pipe (using the fixing piece).

### DETAILED DESCRIPTION OF THE INVENTION

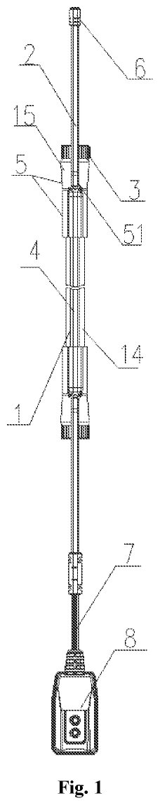

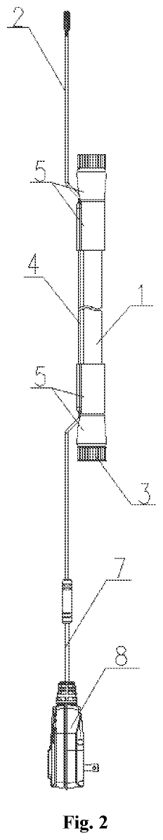

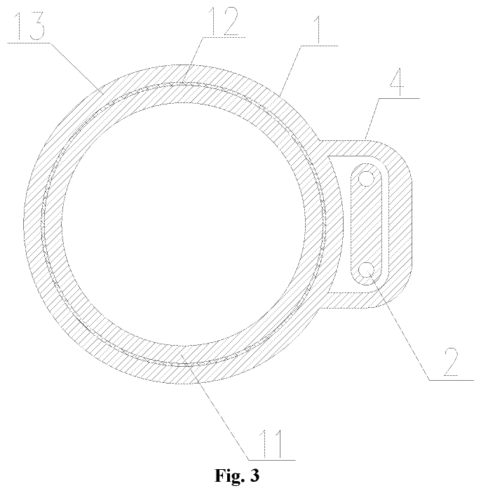

Embodiment 1: referring to FIG. 1 to FIG. 3, a multifunctional pipe includes a water pipe 1 and a cable 2. A water pipe connector 3 is arranged at each of the ends of both sides of the water pipe 1. The water pipe connector 3 may be connected to a water faucet, and may also be connected to a pipeline in a water supply system. An electric pipe sleeve 4 is arranged on one side of the water pipe 1, and the electric pipe sleeve 4 is formed by extruding the cable 2. The electric pipe sleeve 4 formed by extruding an outer surface of the cable 2 and a water pipe jacket 13 formed by extruding an outer surface of the water pipe 1 are of an integrally formed integral structure. Two ends of both sides of the cable 2 extend out of the ends of the corresponding sides of the electric pipe sleeve 4. The electric pipe sleeve 4 and the water pipe jacket 13 (an outer PVC layer) are made of a PVC material. The cable 2 is a self-temperature-limiting heating tape, or the cable 2 is a conductive wire, or the cable 2 is a self-temperature-limiting heating tape and a conductive wire. After the electric pipe sleeve 4 wraps the cable 2, the pipe realizes the separation of water from electricity, and improves the applicability.

When the cable 2 is a self-temperature-limiting heating tape, the arrangement of the electric pipe sleeve 4 can also ensure that the self-temperature-limiting heating tape heats the electric pipe sleeve 4 stably. When the multifunctional pipe (the cable 2 is a self-temperature-limiting heating tape) is mounted in a water supply system (such as a water supply system of a touring car), the self-temperature-limiting heating tape 2 can heat the water in the water pipe 1; and since the water in the water pipe 1 and the water in the water supply system are integrated, an icing phenomenon of the water in the water supply system can be avoided. The self-temperature-limiting heating tape 2 heats by using a temperature sensitive resistor. The lower the outside temperature, the more the heat generated by the temperature sensitive resistor. The heat generated by the self-temperature-limiting heating tape 2 is about 30° C.

The water pipe 1 consists of an intermediate pipe section 14 and two flared pipe sections 15. The flared pipe section 15 is horn-shaped, a wide mouth diameter of the flared pipe section 15 is matched with the diameter of the water pipe connector 3, and a narrow mouth diameter of the flared pipe section 15 is matched with the diameter of the intermediate pipe section 14. The intermediate pipe section 14 and the two flared pipe sections 15 are of an integrated structure. A sheath 5 is arranged on each of the ends of both sides of the water pipe 1 in a sleeving manner, and the sheath 5 covers the corresponding flared pipe section 15 and part of the intermediate pipe section 14, that is, the length of the sheath 5 is greater than that of the flared pipe section 15. The length of the parts, extending out the two ports of the electric pipe sleeve 4, of the self-temperature-limiting heating tape 2 is greater than that of the corresponding flared pipe section 15. One or more threading holes 51 for the self-temperature-limiting heating tape 2 to penetrate out are formed in the sheath 5, and the self-temperature-limiting heating tape 2 can penetrate outside through the threading hole 51. When there are a plurality of threading holes 51, the plurality of threading holes 51 are distributed in a “1”-shape along a symmetrical center line of the sheath 5. The sheath 5 is made of sponge, or is made of rubber.

The water pipe 1 consists of an inner PVC layer 11, an intermediate yarn layer 12, and an outer PVC layer, and the intermediate yarn layer 12 is located between the inner PVC layer 11 and the outer PVC layer. The outer PVC layer is the water pipe jacket 13. The inner PVC layer 11 is made of a PVC material up to a drinking water pipe grade.

A rubber coating 6 is arranged at an end of one side of the self-temperature-limiting heating tape 2, and the end of the other side is connected to a power supply through a power line 7 and a leakage protector 8.

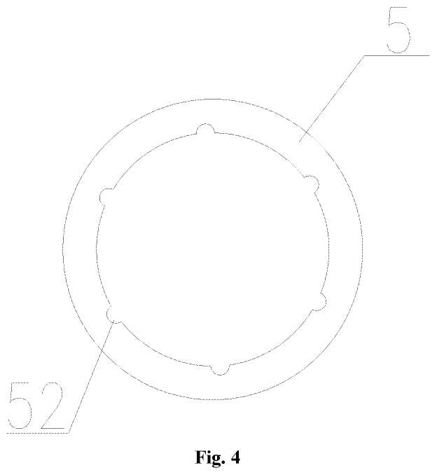

Embodiment 2: reference is made to FIG. 4 on the basis of Embodiment 1. A plurality of grooves 52 are formed in an inner wall surface of the sheath 5 in a direction of the symmetrical center line of the sheath 5, and the grooves 52 penetrate through the end surfaces of both sides of the sheath 5. The diameter of the intermediate pipe section 14 is greater than that of the inner wall surface of the sheath 5.

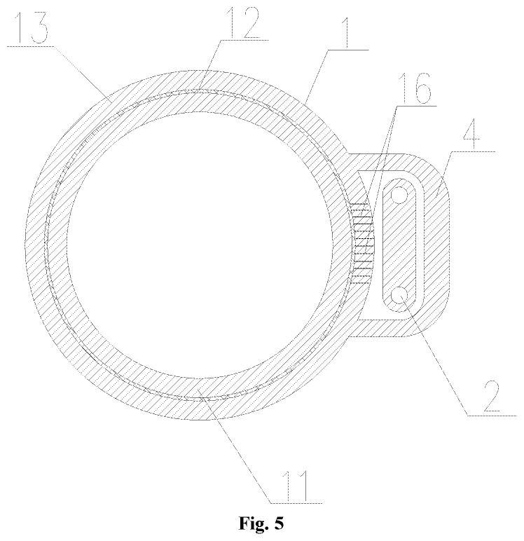

Embodiment 3: reference is made to FIG. 5 on the basis of Embodiment 1 and Embodiment 2. The intermediate yarn layer 12 is a metal ring woven by metal wires. A directional heat conductor formed by a metal wire section 16 is arranged on one side of the metal ring and the directional heat conductor is coated in the outer PVC layer. The directional heat conductor directly faces an inner cavity of the electric pipe sleeve 4, and an outer end of the metal wire section 16 in the directional heat conductor does not extend out of an inner cavity wall of the electric pipe sleeve 4. The cable 2 arranged in the electric pipe sleeve 4 is a self-temperature-limiting heating tape. The distance between the end of the metal wire and the inner wall surface of the electric pipe sleeve 4 is 0.1 mm to 0.3 mm. Preferably, the distance between the end of the metal wire and the inner wall surface of the electric pipe sleeve 4 is 0.2 mm. The metal wire is a heat conducting metal wire. Remaining this thickness distance, the metal wire section 16 cannot poke through the inner cavity wall of the electric pipe sleeve 4 during use. Meanwhile, the thickness distance does not affect the directional heat conductor to absorb the heat generated by the self-temperature-limiting heating tape 2. The metal wire section 16 is formed by the ends of metal wires weaving the metal ring.

Further, the metal ring is spirally arranged on the inner PVC layer in a sleeving manner, so that the water pipe 1 maintains good bending performance, and meanwhile, heat may be transferred between ring sections of the whole metal ring by using a continuous structure of the whole metal ring, which further improves the utilization rate of the heat. When the metal ring is spiral, the metal ring has a plurality of ring sections facing an inner cavity of the electric pipe sleeve 4. The directional heat conductor 16 is located at the part, facing the inner cavity of the electric pipe sleeve 4, of each ring section, so that the directional heat conductor 16 on each ring section is distributed in an inclined direction. The distribution range is matched with the width of the self-temperature-limiting heating tape, so that the heat generated by the self-temperature-limiting heating tape may be comprehensively transferred inside the water pipe.

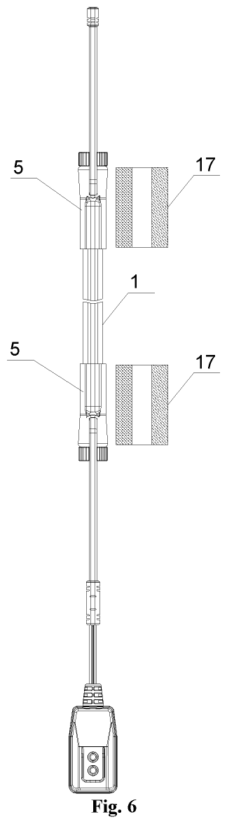

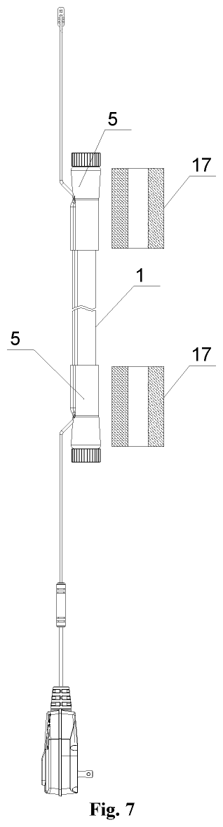

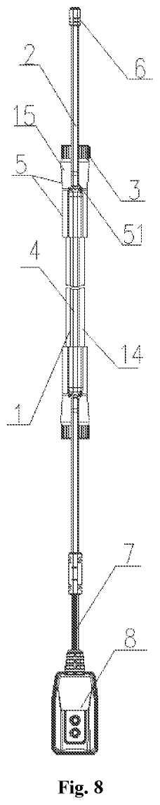

Embodiment 4: as shown in FIG. 6 to FIG. 7, the multifunctional pipe further includes a fixing piece 17. The fixing piece 17 is arranged to fix and fit the self-temperature-limiting heating tape to a water pipe connector 3, so that the fitting degree between the self-temperature-limiting heating tape and the water pipe connector 3 can be improved. When the water pipe connector 3 is connected to a water faucet, the connection can be prevented from icing. Each of both ends of the water pipe 1 is provided with the water pipe connector 3, so that the fixing piece 17 is mounted on the water pipe connector 3 at each of both ends of the water pipe 1.

As shown in FIG. 6 to FIG. 7, in order to further facilitate the fitting of the self-temperature-limiting heating tape to the water pipe connector 3, the fixing piece 17 is a Velcro tape arranged on the water pipe connector 3 in a winding manner. One side of the Velcro tape is a loop surface, and the other side is a hook surface. During use, the Velcro tape may be wound on the water pipe 1, and an upper end of the Velcro tape wraps the water pipe connector 3. At this moment, the loop surface and the hook surface of the Velcro tape are in contact with each other, so as to fit the self-temperature-limiting heating tape to the water pipe connector 3, thereby realizing the fitting and fixing of the self-temperature-limiting heating tape and the water pipe connector 3.

It should be understood that: although the design idea of the present invention is described in detail through a text in the abovementioned embodiments, these text descriptions are only simple text descriptions of the design idea of the present invention rather than limitations to the design idea of the present invention. Any combination, addition or modification that does not exceed the design idea of the present invention falls within the scope of protection of the present invention.

I claim:

1. A multifunctional pipe, comprising:
a water pipe;
a cable;
a water pipe connector arranged at each of the ends of both sides of the water pipe;
an electric pipe sleeve being arranged on one side of the water pipe and is being formed by extruding the cable;
wherein the electric pipe sleeve is formed by extruding an outer surface of the cable; and
a water pipe jacket formed by extruding an outer surface of the water pipe are of an integrally formed integral structure,
wherein two ends of both sides of the cable extend out of the ends of the corresponding sides of the electric pipe sleeve.

2. The multifunctional pipe, according to claim 1, wherein the cable is comprised of a conductive wire.

3. The multifunctional pipe, according to claim 1, wherein the cable is comprised of a self-temperature-limiting heating tape, or a self-temperature-limiting heating tape and a conductive wire.

4. The multifunctional pipe, according to claim 3, wherein the water pipe consists is comprised of an intermediate pipe section and two flared pipe sections; wherein the flared pipe section is horn-shaped;
wherein a wide mouth diameter of the flared pipe section is matched with the diameter of the water pipe connector, and
wherein a narrow mouth diameter of the flared pipe section is matched with the diameter of the intermediate pipe section.

5. The multifunctional pipe, according to claim 4, further comprising: a sheath is being arranged on each of the ends of both sides of the water pipe in a sleeving manner, wherein said sheath covers the corresponding flared pipe section and part of the intermediate pipe section; and wherein the length of the parts, extending out from two ports of the electric pipe sleeve, of the self-temperature-limiting heating tape is greater than that of the corresponding flared pipe section.

6. The multifunctional pipe, according to claim 5, wherein one or more threading holes for the self-temperature-limiting heating tape to penetrate out are formed in the sheath; and wherein, when there are a plurality of threading holes, the plurality of threading holes are distributed in a “1”-shape along a symmetrical center line of the sheath.

7. The multifunctional pipe, according to claim 5, wherein a plurality of grooves are formed in an inner wall surface of the sheath in a direction of the symmetrical center line of the sheath, and wherein the grooves penetrate through the end surfaces of both sides of the sheath.

8. The multifunctional pipe, according to claim 3, wherein the water pipe is comprised of an inner Polyvinyl Chloride (PVC) layer, an intermediate yarn layer, and an outer PVC layer; wherein the intermediate yarn layer is located between the inner PVC layer and the outer PVC layer; and wherein the outer PVC layer is the water pipe jacket.

9. The multifunctional pipe, according to claim 8, wherein the intermediate yarn layer is a metal ring woven by metal wires; and wherein a directional heat conductor formed by a metal wire section is arranged on one side of the metal ring and the directional heat conductor is coated in the outer PVC layer.

10. The multifunctional pipe, according to claim 9, wherein the a metal ring is spirally arranged on the inner PVC layer in a sleeving manner.

11. The multifunctional pipe, according to claim 10, wherein the directional heat conductor directly faces an inner cavity of the electric pipe sleeve; wherein an outer end of the metal wire section in the directional heat conductor does not extend out of an inner cavity wall of the electric pipe sleeve; and wherein the cable arranged in the electric pipe sleeve is a self-temperature-limiting heating tape.

12. The multifunctional pipe, according to claim 11, further comprising: a rubber coating is arranged at an end of one side of the self-temperature-limiting heating tape, and wherein the end of the other side is connected to a power supply through a power line and a leakage protector.

13. The multifunctional pipe, according to claim 10, further comprising; a fixing piece, wherein the fixing piece is arranged to fix and fit the self-temperature-limiting tape to the water pipe connector.

14. The multifunctional pipe, according to claim 13, wherein the fixing piece is a hook and ladder tape arranged on the water pipe connector; wherein a first end of the hook and ladder type tape is fixed to the water pipe connector; and wherein a second end is arranged on the water pipe connector in a winding manner.
